(19) United States
(12) Patent Application Publication
(10) Pub. No.: US 2013/0197863 A1
(43) Pub. Date: Aug. 1, 2013

(54) PERFORMANCE AND CAPACITY ANALYSIS OF COMPUTING SYSTEMS

(71) Applicant: Tata Consultancy Services Limited, Mumbai (IN)

(72) Inventors: Ajinkya Rayate, Pune (IN); Arpit Patel, Pune (IN); Anjali Gajendragadkar, Pune (IN); Rahul Kelkar, Pune (IN); Harrick Vin, Pune (IN)

(73) Assignee: Tata Consultancy Services Limited, Mumbai (IN)

(21) Appl. No.: 13/753,874

(22) Filed: Jan. 30, 2013

(30) Foreign Application Priority Data
Jan. 31, 2012 (IN) 299/MUM/2012

(51) Int. Cl. G06F 11/30

(52) U.S. Cl. CPC G06F 11/3051
USPC 702/186

(57) ABSTRACT

The present subject matter relates to systems and methods for assessing performance and capacity of computing systems. In one implementation, the method comprises identifying at least one gap in a plurality of benchmark data sets of the computing systems; ascertaining at least one of a maximum ratio, a minimum ratio, and an average ratio of values present in the plurality of benchmark data sets; and generating at least one value to fill the at least one gap based in part on the ascertaining. The method further comprises defining a normalized benchmark data sheet based in part on the generating; and determining a performance and capacity score (P/C score), indicative of performance and capacity of the computing systems, based in part on the normalized benchmark data sheet.

### CLAIM OF PRIORITY

This application claims the benefit of priority under 35 U.S.C. §119 of Indian Patent Application Serial Number 299/MUM/2012, entitled “PERFORMANCE AND CAPACITY ANALYSIS OF COMPUTING SYSTEMS,” filed on Jan. 31, 2012, the benefit of priority of which is claimed hereby, and which is incorporated by reference herein in its entirety.

### TECHNICAL FIELD

The present subject matter is related, in general to assessing performance of computing systems and, in particular, but not exclusively to a method and system for comparing performance and capacity of the computing systems.

### BACKGROUND

Advancement in the fields of information technology (IT) and computer science has led many organizations to make IT an integral part of their business leading to high investments in computer devices like servers, routers, switches, storage units, etc. Usually a data centre is used to house the equipments required for implementing the IT services. Conventionally, every type of organization has data centre, which aims to control the main IT services, such as the Internet connectivity, intranets, local area networks (LANs), wide area networks (WAN), data storage, and backups. Data centers comprise IT systems or computing systems that include computer devices, together with associated components like storage systems and communication systems. Further, the data centre also includes non-IT systems like active and redundant power supplies, uninterrupted power supply (UPS) system, safety and security devices, like access control mechanisms, fire suppression devices, environmental control systems like air conditioning devices, lighting systems, etc.

Typically, the data centres of any organization have different kinds of computing systems to perform various aspects of the organization's operations. For example, an organization which provides international banking services may have multiple geographically dispersed data centers hosting various kinds of computing systems, to cover their service area. In said example, the computing systems may be running different applications to provide a variety of different services, such as net banking, phone banking, third party transfers, automatic teller machine (ATM) transactions, foreign exchange services, bill payment services, credit card/debit card services, and customer support. Based on the applications and the services running on the computing systems, the computing systems may vary in performance and capacity.

With the advent of technology, a wide range of computing systems is available. The computing systems may vary in their configuration, and thus, have varied performance and capacity. For example, the computing systems may vary based on the number of processors, the type of processors, number and types of hard disks, the number and type of random access memory (RAM) modules, the number and type of network interfaces, manufacturer, make and so on.

With the growth of the organization over time; the need for addition, upgradation or removal of some of the computing systems, hosted in the data centers, may arise. The addition, upgradation or removal of the computing systems usually needs careful monitoring so that the sum total of performance and capacity of the computing systems hosted the data centers meets the current and planned future needs of the organization.

### SUMMARY

This summary is provided to introduce concepts related to performance and capacity analysis of computing systems, and the concepts are further described below in the detailed description. This summary is not intended to identify essential features of the claimed subject matter nor is it intended for use in determining or limiting the scope of the claimed subject matter.

In one implementation, a method to compare performance and capacity analysis of computing systems is provided. In one implementation, the method includes identifying at least one gap in a plurality of benchmark data sets of the computing systems; ascertaining at least one of a maximum ratio, a minimum ratio, and an average ratio of values present in the plurality of benchmark data sets; and generating at least one value to fill the at least one gap based in part on the ascertaining. The method further comprises defining a normalized benchmark data sheet based in part on the generating; and determining a performance and capacity score (P/C score), indicative of performance and capacity of the computing systems, based in part on the normalized benchmark data sheet.

### BRIEF DESCRIPTION OF THE DRAWINGS

The present subject matter and other features and advantages thereof will become apparent and may be better understood from the following drawings. The components of the figures are not necessarily to scales, emphasis instead being placed on better illustration of the underlying principle of the subject matter. Different numeral references on figures designate corresponding elements throughout different views. In the figure(s), the left-most digit(s) of a reference number identifies the figure in which the reference number first appears. The same numbers are used throughout the drawings to reference like features and components. The detailed description is described with reference to the accompanying figure(s).

FIG. 1 illustrates the exemplary components of a performance and capacity analysis system in a network environment, in accordance with an implementation of the present subject matter.

FIG. 2 illustrates a method for comparing performance and capacity of computing systems, in accordance with an implementation of the present subject matter.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

Systems and methods for comparing performance and capacity of computing systems are described therein. The systems and methods can be implemented in a variety of computing devices, such as laptops, desktops, workstations, tablet-PCs, smart phones, notebooks or portable computers, tablet computers, mainframe computers, mobile computing devices, entertainment devices, computing platforms, internet appliances, and similar systems. However, a person skilled in the art will comprehend that the embodiment of the present subject matter are not limited to any particular computing system, architecture or application device, as it may be adapted to take advantage of new computing system and platform as they become accessible.

Organizations now extensively use computing systems to manage their operations. The computing systems are typically hosted in one or more data centers of the organizations. The data centers hosts various computing systems which vary in the number of processors, the type of processors, family and generation of processors, number and types of hard disks, the number and type of random access memory (RAM) modules, the number and type of network interfaces, manufacturer, make, and so on. Typically there are pre-defined proprietary benchmark data for every type of computing systems. It will be well understood by those skilled in the art that the benchmark data for a computing system may vary based on a benchmark vendor, i.e., a vendor which defines benchmark for assessing the performance and capacity of computing systems; the configuration of the computing system, the purpose of the computing system, and so on. For example, the benchmark data defined for a computing system which is used as a mail server, will vary from the benchmark data defined for a computing system which is being used as a database server. Further, a benchmark data for a computing system having a single core multi core processor, such as quad-core processor.

Moreover, the benchmark data defined for each kind of computing system may vary based on the vendor defining the benchmark. Examples of vendors defining benchmark data for various kinds of computing systems include SPEC, TPCC, mValues, and so on. The benchmark data are indicative of various performance and capacity parameters, collectively referred to as benchmark parameters, of the computing systems. The performance parameters may be understood to be indicative of the speed at which the computing system may do its tasks; wherein the capacity parameters may be indicative of the maximum simultaneous workload that may be handled by the computing systems.

With time, the organization's requirements may change, and thus an upgradation or addition or removal of computing systems may be done in the organizations' data centers. For example, the organization may perform server consolidation, which is regarded, by the IT industry, as an approach to the efficient usage of computing resources. Server consolidation aims to reduce the total number of computing systems that the organization may require, thus resulting in an increased efficiency in terms of utilization of space and resources, such as power. For example, one new computing system, having high performance and capacity parameters, may replace several old computing systems having low performance and capacity parameters.

However, replacing computing systems in a data centre is a complex task. The new computing systems should match up with the replaced computing systems, in terms of performance and capacity parameters. Further, the new computing systems should be selected based on an estimated increase in workload that the organization may be required to handle in the future, due to say, expansion in operations, new business opportunities, and so on. For the selection, an assessment the performance and capacity parameters of the computing systems, for example, by comparing the new computing systems and the replaced computing systems, benchmark data of the computing systems are used. As mentioned, earlier, the benchmark data provided by various vendors vary in terms of performance and capacity parameters tested, and in terms of the format used. Moreover, the benchmark data conventionally available do not facilitate comparison of computing systems, which have different architecture, for example, complex instruction set computer (CISC) architecture, and reduced instruction set computer (RISC) architecture. Further, the benchmark data defined by the various vendors gets updated quite fast, whereas data centers continue hosting the old computing systems. Thus it becomes difficult to compare computing systems which vary in terms of architecture, model, manufacturer, generation, and so on.

The present subject matter describes systems and methods for performance and capacity analysis of computing systems. In one implementation, the performance and capacity of a computing system is indicated by a performance-capacity score, henceforth referred to as P/C score. The computing systems may include servers, network servers, storage systems, mainframe computers, laptops, desktops, workstations, tablet-PCs, smart phones, notebooks or portable computers, tablet computers, mobile computing devices, entertainment devices, and similar systems. It should be appreciated by those skilled in the art that although the systems and methods for performance and capacity analysis of computing systems are described in the context of comparing computing systems in a data centre, the same should not be construed as a limitation. For example, the systems and methods for performance and capacity analysis of computing systems may be implemented for various other purposes, such as for planning and implementing system migration, designing data centres; and planning and implementing server virtualization techniques.

In one implementation, the method of performance and capacity analysis of computing systems includes receiving the benchmark data for various computing systems, as defined by multiple vendors. The benchmark data may be for various computing systems, which may differ based on the model, manufacturer, make, family, generation, constituent components, and so on. The received benchmark data is then analyzed to detect one or more gaps in the received benchmark data. The gaps may be caused to the vendors of the benchmark data not providing values for one or more performance parameters and/or capacity parameters.

In one embodiment of the systems and methods for performance and capacity analysis of computing systems described here, such gaps in benchmark data are determined. The determined gaps are then supplemented with new parameter values computed based on the values which are already available in the benchmark data. For example, the gaps may be completed with new values based on a ratio technique. In said ratio technique, the new values are computed based in part on at least one of a maximum ratio, a minimum ratio, and an average ratio of the available values. In another implementation, each of the maximum ratio, the minimum ratio, and the average ratio may be associated with a ration weightage parameter, based on the benchmark parameter the ratio pertains to, the new values may be determined based on the weighted average of the ratios. Yet in another example, the new values may be based in part on non benchmark parameters, such as number of cores, memory space available, frequency of clock cycle, and number of processor cores.

On the completion of computation of the new values, a normalized benchmark data sheet is generated which may be taken to be the new benchmark data to compare the various different computing systems. The performance parameters and the capacity parameters of the computing systems hosted in the data centre may be determined with respected to the normalized benchmark data sheet. In one implementation, a normalized benchmark score, the P/C score, may be determined for each of the computing systems hosted in the data centre. In said implementation, the new computing system may be deemed to be fit to replace a plurality of the old computing system, if the P/C score of the new computing system is greater than or equal to the sum of the P/C scores of the old computing systems being replaced.

Thus, the systems and methods for performance and capacity analysis of computing systems provide flexibility to a user to compare the performance and capacity of different computing systems against a common benchmark. The present subject matter further facilitates easy upgradation of data centers which hosts computing systems of a wide range. These and other features of the present subject matter would be described in greater detail in conjunction with the following figures. While aspects of described systems and methods for performance and capacity analysis of computing systems may be implemented in any number of different computing systems, environments, and/or configurations, the embodiments are described in the context of the following exemplary system(s).

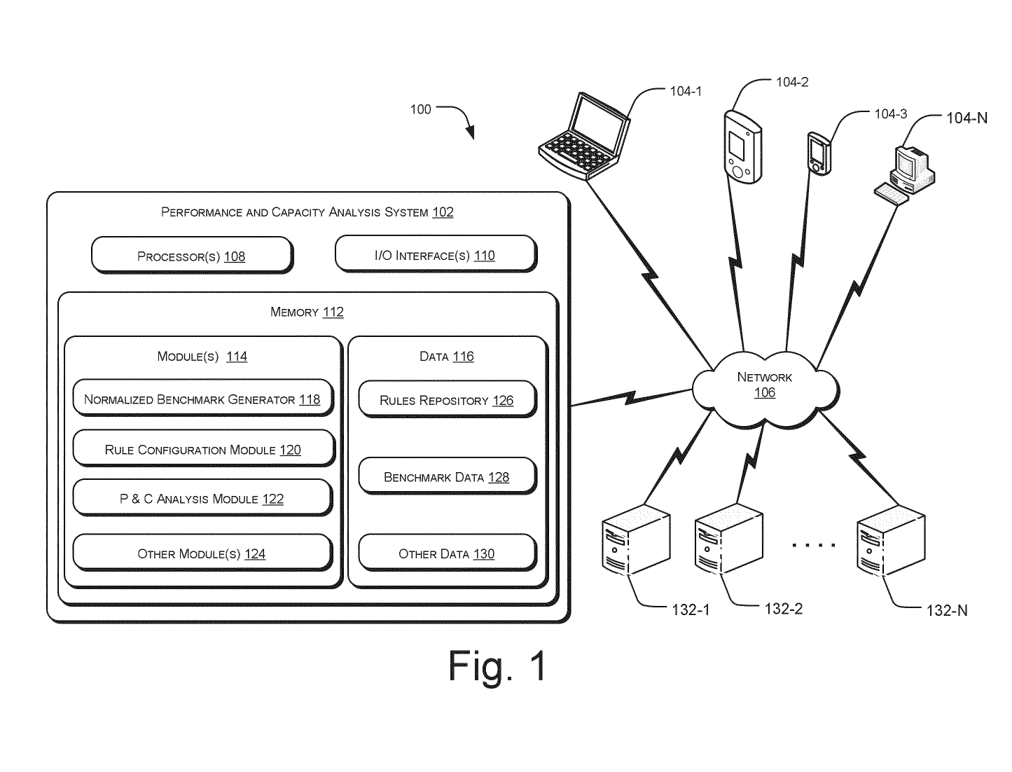

FIG. 1 illustrates an exemplary network environment 100 implementing a performance and capacity analysis systems 102, henceforth referred to as the PCA system 102, according to an embodiment of the present subject matter. In said embodiment, the network environment 100 includes the PCA system 102, configured to analyze the performance and capacity of a plurality computing systems, such as the computing systems 103, coupled to the PCA system 102. In one example, the plurality of computing systems 103 may be a part of a data center of an organization. In said implementation, the PCA system 102 may be included within an existing information technology infrastructure system associated with the organization. In other implementation, the plurality of computing systems may be discrete devices coupled, for example, through a network 106 to the PCA system 102 for the purpose of assessment of their performance and capacity.

In one implementation, the network environment 100 also includes various computing systems, such as computing systems 103-1, 103-2, . . . , 103-N, which are located in one or more data centres of the organization and whose performance and capacity is to be analyzed by the PCA system 102. The computing systems 103-1, 103-2, . . . , 103-N, are collectively referred to as the computing systems 103, and singularly as the computing system 103. Though the PCA system 102 has been shown to be connected with the computing systems 103, through the network 106; it should be appreciated by those skilled in the art, that in other implementations, the computing systems 103 may be connected to the PCA system 102 directly.

The PCA system 102 may be implemented in a variety of computing systems, such as a laptop computer, a desktop computer, a notebook, a workstation, a mainframe computer, a server, and the like. It will be understood that the PCA system 102 may be accessed by various stakeholders, such as the data centre administrator, using client devices 104 or applications residing on client devices 104. Examples of the client devices 104 include, but are not limited to, a portable computer 104-1, a mobile computing device 104-2, a handheld device 104-3, a workstation 104-N, etc. As shown in the figure, such client devices 104 are also communicatively coupled to the PCA system 102 through the network 106 for facilitating one or more stakeholders to analyze the PCA system 102.

The network 106 may be a wireless network, wired network or a combination thereof. The network 106 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further the network 106 may include a variety of network devices, including routers, bridges, servers, computing devices, storage devices, etc.

In one implementation, the PCA system 102 includes a processor 108, input-output (I/O) interface(s) 110, and a memory 112. The processor 108 is coupled to the memory 112. The processor 108 may be implemented as one or more microprocessors, microcomputers, microcontrollers, digital signal processors, central processing units, state machines, logic circuitries, and/or any devices that manipulate signals based on operational instructions. Among other capabilities, the processor 108 is configured to fetch and execute computer-readable instructions stored in the memory 112.

The I/O interface(s) 110 may include a variety of software and hardware interfaces, for example, a web interface, a graphical user interface, etc., allowing the PCA system 102 to interact with the client devices 104. Further, the I/O interface(s) 110 may enable the PCA system 102 to communicate with other computing devices, such as web servers and external data servers (not shown in figure). The I/O interface(s) 110 can facilitate multiple communications within a wide variety of networks and protocol types, including wired networks, for example, LAN, cable, etc., and wireless networks, such as WLAN, cellular, or satellite. The I/O interface(s) 110 may include one or more ports for connecting a number of devices to each other or to another server.

The memory 112 can include any computer-readable medium known in the art including, for example, volatile memory (e.g., RAM), and/or non-volatile memory (e.g., EPROM, flash memory, etc.). In one embodiment, the memory 112 includes module(s) 114 and data 116. The module(s) 114 further include a normalized benchmark generator 118, a rule configuration module 120, a performance and capacity analysis module 122, henceforth referred to as the PCA module 122, and other module(s) 124. It will be appreciated that such modules may be represented as a single module or a combination of different modules. Additionally, the memory 112 further includes data 116 that serves, amongst other things, as a repository for storing data fetched processed, received and generated by one or more of the module(s) 114. The data 116 includes, for example, a rules repository 126, benchmark data 128, and other data 130. In one embodiment, the rule repository 126, the benchmark data 128, and the other data 130, may be stored in the memory 112 in the form of data structures. Additionally, the aforementioned data can be organized using data models, such as relational or hierarchical data models.

In operation, the normalized benchmark generator 118 may be configured to receive one or more benchmark data sheets defined by one or more vendors for various types of computing systems 103. In one implementation, the various stakeholders may upload the benchmark data sheets using the client devices 104. The received benchmark data sheets are analyzed by the normalized benchmark generator 118 to detect gaps. The gaps may be understood to be benchmark parameters for which at least one benchmark data sheet does not have a value. In one implementation, the rule configuration module 120 facilitates the stakeholders to define various rules for filling the benchmark data sheets. These rules may be saved in the rules repository 126. Based on these rules, the normalized benchmark generator 118 may be configured to fill the gaps in the benchmark data sheets.

In one implementation, the normalized benchmark generator 118 may analyze the historical benchmark data of the specific type of the computing system to compute values to fill the gaps. In another implementation, the normalized benchmark generator 118 may be configured to compute values to fill the gaps by comparing benchmark data sheets of similar computing systems. In said implementation, the normalized benchmark generator 118 may be configured to generate a similarity index indicative of the similarity in configuration of the computing systems. Yet in another implementation, the normalized benchmark generator 118 may be configured to fill missing values, i.e., gaps, in a benchmark data sheet based on the benchmark data sheet's relationship with other benchmark data sheets.

For example, the normalized benchmark generator 118 may generate a best fit curve for all the benchmark datasheets and determine the missing values based on the same. In another example, the normalized benchmark generator 118 may determine at least one of a maximum ration, minimum ratio, and an average ration, of the already filled values and based on the same, compute the values to fill the gaps. Based on one or more techniques of computing the missing values, the normalized benchmark generator 118 computes the values to fill the gaps in the benchmark data sheets. The normalized benchmark generator 118 may be further configured to save the completed benchmark data sheets as the benchmark data 128.

Based on the normalized benchmark data sheet so generated, the PCA analysis module 122 may be configured to determine a P/C score for each of the computing systems 103. The PCA analysis module 122 may be configured to determine a maximum, minimum, and an average PCA score for the computing systems 103 so as to compare the same.

Thus the PCA system 102 facilitates determination of the performance and capacity parameters of various computing systems 103, with respect to a common normalized benchmark data sheet. Further, the PCA system 102 facilitates comparison of computing systems, such as the computing systems 103, across various generations, families, architecture, and so on.

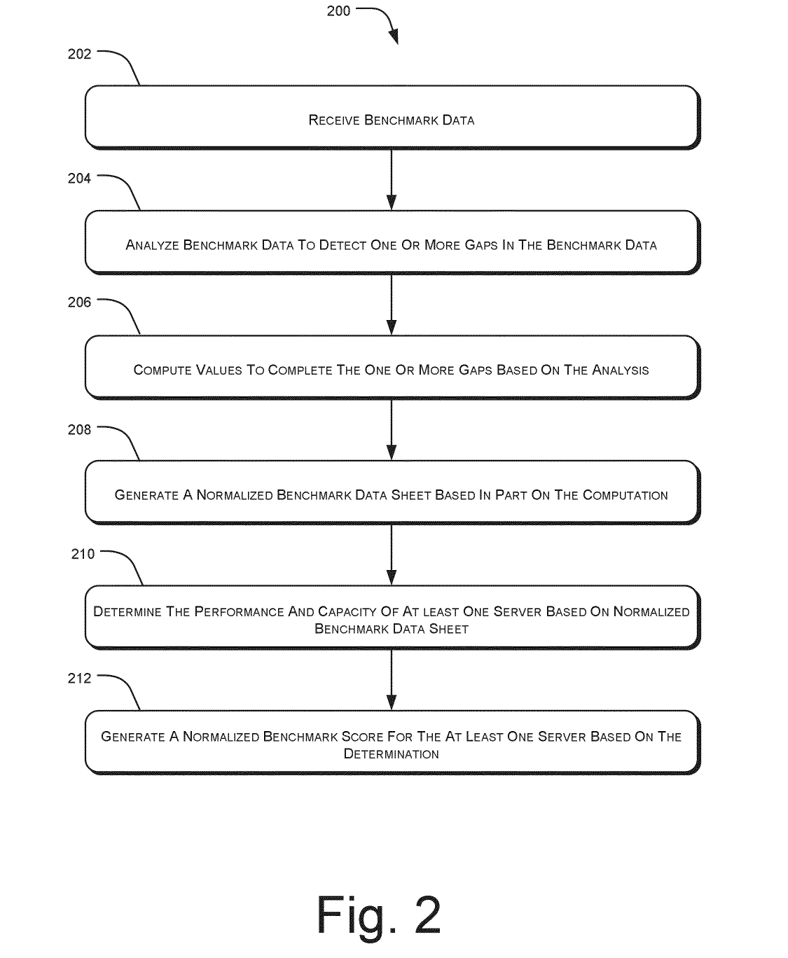

FIG. 2 illustrates a method 200 of performance and capacity analysis of computing systems, in accordance with an implementation of the present subject matter. The exemplary method may be described in the general context of computer executable instructions. Generally, computer executable instructions can include routines, programs, objects, components, data structures, procedures, modules, functions, and the like that perform particular functions or implement particular abstract data types. The method may also be practiced in a distributed computing environment where functions are performed by remote processing devices that are linked through a communication network. In a distributed computing environment, computer executable instructions may be located in both local and remote computer storage media, including memory storage devices.

The order in which the method is described is not intended to be construed as a limitation, and any number of the described method blocks can be combined in any order to implement the method, or alternate methods. Additionally, individual blocks may be deleted from the method without departing from the spirit and scope of the subject matter described herein. Furthermore, the method can be implemented in any suitable hardware, software, firmware, or combination thereof. The method described herein is with reference to the PCA system 102; however, the method can be implemented in other similar systems albeit with a few variations as will be understood by a person skilled in the art.

At block 202, the benchmark data of various vendors is received. For example, in one implementation, the normalized benchmark generator 118 may be configured to receive benchmark data of various vendors. The table-1 below depicts a sample benchmark data received by the normalized benchmark generator 118.

TABLE 1

| | No of | Bench- | Bench- | | |
|---|---|---|---|---|---|
| | Processor | mark | mark | Benchmark | Benchmark |
| Model | Cores | Data A | Data B | Data C | Data D |
| Model A | 2 | 10.1 | 0 | 17.5 | Not Available |
| Model B | 2 | 12.6 | 13.9 | 22.6 | 25.2 |
| Model C | 1 | 9.02 | 0 | NULL | NULL |

At block 204, the received benchmark data is analyzed to detect gaps in the received benchmark data. In one implementation, the normalized benchmark generator 118 may be configured to determine the gaps based on presence of keywords, such as “Null”, “Not Available”, “N/A”, “0”, and blank spaces. The table-2 below depicts the identified gaps, indicated by the word “GAP”, in the received benchmark data.

TABLE 2

| | No of | Bench- | Bench- | | |
|---|---|---|---|---|---|
| | Processor | mark | mark | Benchmark | Benchmark |
| Model | Cores | Data A | Data B | Data C | Data D |
| Model A | 2 | 10.1 | GAP | 17.5 | GAP |
| Model B | 2 | 12.6 | 13.9 | 22.6 | 25.2 |
| Model C | 1 | 9.02 | GAP | GAP | GAP |

As shown in block 206, values are computed so as to fill the gaps. In one implementation, the normalized benchmark generator 118 may be configured to use non benchmark parameters, such as number of cores in the processor, so as to standardize the various benchmark data. For example, the Benchmark Data A and the Benchmark Data B, may be adjusted in the proportion of number of cores in the processor. Based on the same, the values of the received benchmark data may be revised as depicted in Table-3.

TABLE 3

| | No of | Bench- | Bench- | | |
|---|---|---|---|---|---|
| | Processor | mark | mark | Benchmark | Benchmark |
| Model | Cores | Data A | Data B | Data C | Data D |
| Model A | 2 | 20.2 | GAP | 17.5 | GAP |
| Model B | 2 | 25.2 | 27.8 | 22.6 | 25.2 |
| Model C | 1 | 9.02 | GAP | GAP | GAP |

After, the revision of the revised benchmark data, the gaps may be filled with values computed based on benchmark parameters. In one example, say the minimum ratio of available values is being considered for generating values to fill the identified gaps. For example, the values for the benchmark data B are filled in the minimum ratio of available values. The table-4 below depicts the benchmark data after the computations have been completed for Model A.

TABLE 4

| | No of | Bench- | Bench- | | |
|---|---|---|---|---|---|
| | Processor | mark | mark | Benchmark | Benchmark |
| Model | Cores | Data A | Data B | Data C | Data D |
| Model A | 2 | 20.2 | 24.24 | 17.5 | 21 |
| Model B | 2 | 25.2 | 27.8 | 22.6 | 25.2 |
| Model C | 1 | 9.02 | 10.824 | GAP | GAP |

In one implementation, the normalized benchmark generator 118 is further configured to determine the maximum integer values for each of the rows. Table 5 shows the determined maximum integer values.

TABLE 5

| Model | Maximum Integer |
|---|---|
| Model A | 24 |
| Model B | 27 |
| Model C | 10 |

In one implementation, the normalized benchmark generator 118 may be configured to generate the ratios between the various benchmark data for the models, which have the least or no missing values. For example, Model A and Model B have values for all the available benchmarks. However, for Model C, the Benchmark Data C and Benchmark Data D has gaps. In said example, the ratio of the values of Benchmark Data B, which stores the maximum integer value, with the values of Benchmark Data C and Benchmark Data D are computed. Table-6 shows the result of such a computation.

TABLE 6

| | Benchmark Data B/ | Benchmark Data B/ |
|---|---|---|
| Model | Benchmark Data C | Benchmark Data D |
| Model A | 1.385 | 1.154 |
| Model B | 1.2301 | 1.1032 |

In said implementation, the normalized benchmark generator 118 may be configured to select the minimum ratio for each benchmark data so as to generate values to fill the gaps. For example, for computing the values for computing gaps in the Benchmark Data C, the ratio, 1.2301, may be selected; whereas for Benchmark Data D, the ratio 1.1032 may be selected. Table-7 below depicts the completed benchmark data sheet.

TABLE 7

| | No of | Bench- | Bench- | | |
|---|---|---|---|---|---|
| | Processor | mark | mark | Benchmark | Benchmark |
| Model | Cores | Data A | Data B | Data C | Data D |
| Model A | 2 | 20.2 | 24.24 | 17.5 | 21 |
| Model B | 2 | 25.2 | 27.8 | 22.6 | 25.2 |
| Model C | 1 | 9.02 | 10.824 | 8.8 | 9.812 |

At block 208, the normalized benchmark data sheet is generated. For example, in one implementation, the normalized benchmark generator 118 may be configured to revise the completed benchmark data based on various benchmark parameters and non-benchmark parameters. The normalized benchmark generator 118 may be further configured to generate a P/C score for each model by combining the values of the various sets of benchmark data. In one implementation, each of the benchmark data sets may be associated with a weightage parameter, indicative of the weightage assigned to the said benchmark data set. In one example, the weightage parameter may be in accordance with the number of benchmark parameters for which a benchmark data set provides values; whereas in another example, the weightage parameter may be in accordance with the release date of the benchmark data set, wherein the most recent benchmark data set is assigned highest weightage and the oldest benchmark data set is assigned the lowest weightage. Table-8 below depicts the P/C score generated for each of the models using the above described techniques and assuming equal weights to all benchmarks.

TABLE 8

| Model | No of Processor Cores | P/C Score |
|---|---|---|
| Model A | 2 | 20.735 |
| Model B | 2 | 25.2 |
| Model C | 1 | 9.614 |

As depicted in block 210, the performance and capacity of various computations, such as the computing systems 103 may be determined. In one implementation, the normalized benchmark generator 118 may be configured to receive the results of various tests provided by the vendors of various benchmark data, so as to determine the performance and capacity of the various computing systems.

As illustrated in block 212, a normalized benchmark score, i.e., the P/C score, may be generated so as to compare the performance and capacity of the various computing systems. In one implementation, the normalized benchmark generator 118 may be configured to perform one or more of the above described steps, so as to determine the P/C sore for the various computing systems, such as the computing systems 103.

Although implementations of performance and capacity analysis of computing systems have been described in language specific to structural features and/or methods, it is to be understood that the present subject matter is not necessarily limited to the specific features or methods described. Rather, the specific features and methods are disclosed as implementations for performance and capacity analysis of computing systems.

We claim:

1. A computer implemented method of assessing performance and capacity of computing systems comprising:
identifying at least one gap in a plurality of benchmark data sets of the computing systems;
ascertaining at least one of a maximum ratio, a minimum ratio, and an average ratio of values present in the plurality of benchmark data sets;
generating at least one value to fill the at least one gap based in part on the ascertaining;
defining a normalized benchmark data sheet based in part on the generating; and
determining a performance and capacity score (P/C score), indicative of performance and capacity of the computing systems, based in part on the normalized benchmark data sheet.

2. The method as claimed in claim 1, wherein the ascertaining is further based on at least one of a maximum ratio, a minimum ratio, and an average ratio of values of non benchmark parameters of the plurality of computing systems.

3. The method as claimed in claim 1, wherein the identifying is based on detecting the presence of at least one keyword in at least one of the plurality of benchmark data sets.

4. The method as claimed in claim 1 further comprises determining a similarity index, indicative of the similarity in configuration of at least two of the computing systems, based in part on at least one non benchmark parameter associated with the computing systems.

5. The method as claimed in claim 1, wherein the generating further comprises:
determining a maximum value in each benchmark data sheet for each of the computing systems; and
determining a ratio of the maximum value with at least another value in the each benchmark data sheet for each of the computing systems.

6. A performance and capacity analysis system (PCA) system, configured to assess performance and capacity of computing systems comprising:
a processor; and
a memory coupled to the processor, the memory comprising
a normalized benchmark generator configured to,
identify at least one gap in a plurality of benchmark
data sets of the computing systems;
ascertain at least one of a maximum ratio, a minimum ratio, and an average ratio of values present in the plurality of benchmark data sets;
generate at least one value to fill the at least one gap based in part on the ascertaining;
define a normalized benchmark data sheet based in part on the generating; and
a performance and capacity analysis (PCA) module configured to
determine a performance and capacity score (P/C score), indicative of performance and capacity of the computing systems, based in part on the normalized benchmark data sheet.

7. The PCA system as claimed in claim 6, wherein the normalized benchmark generator is further configured to determine at least one of a maximum ratio, a minimum ratio, and an average ratio of values of non benchmark parameters of the plurality of computing systems.

8. The PCA system as claimed in claim 6, wherein the normalized benchmark generator is further configured to generate a similarity index, indicative of the similarity in configuration of at least two of the computing systems, based in part on at least one non benchmark parameter associated with the computing systems.

9. The PCA system as claimed in claim 6, wherein the normalized benchmark generator is further configured to
determine a maximum value in each benchmark data sheet for each of the computing systems; and
determine a ratio of the maximum value with at least another value in the each benchmark data sheet for each of the computing systems.

10. The PCA system as claimed in claim 6, wherein the PCA system further comprises a rule configuration module configured to define at least one rule for determining the performance and capacity score.

11. A computer-readable medium having embodied thereon a computer program for executing a method comprising:
identifying at least one gap in a plurality of benchmark data sets of the computing systems;
ascertaining at least one of a maximum ratio, a minimum ratio, and an average ratio of values present in the plurality of benchmark data sets;
generating at least one value to fill the at least one gap based in part on the ascertaining; and
defining a normalized benchmark data sheet based in part on the generating.
